(19) United States
(12) Patent Application Publication
(10) Pub. No.: US 2013/0221772 A1
(43) Pub. Date: Aug. 29, 2013

(54) COOLING STRUCTURE OF ROTOR FOR ROTARY ELECTRIC MACHINE, AND ROTARY ELECTRIC MACHINE

(71) Applicants: Tomohiko MIYAMOTO, Toyota-shi (JP); Yoshitada YAMAGISHI, Okazaki-shi (JP); Noriyuki YAGI, Kariya-shi (JP); Shintaro MASATSUKI, Okazaki-shi (JP); Taketo TAKEUCHI, Nishio-shi (JP); Satoshi MURAKAMI, Nishio-shi (JP)

(72) Inventors: Tomohiko MIYAMOTO, Toyota-shi (JP); Yoshitada YAMAGISHI, Okazaki-shi (JP); Noriyuki YAGI, Kariya-shi (JP); Shintaro MASATSUKI, Okazaki-shi (JP); Taketo TAKEUCHI, Nishio-shi (JP); Satoshi MURAKAMI, Nishio-shi (JP)

(21) Appl. No.: 13/778,945

(22) Filed: Feb. 27, 2013

(30) Foreign Application Priority Data
Feb. 29, 2012 (JP) 2012-043934

(51) Int. Cl. H02K 9/19

(52) U.S. Cl. CPC H02K 9/19
USPC 310/54

(57) ABSTRACT

A cooling structure of a rotor for a rotary electric machine includes: a rotatable shaft that is configured to supply coolant that flows inside the shaft to outside the shaft; a rotor core that is fitted onto the shaft and fixed thereto, and has a coolant flow path for flowing the coolant, in an axial direction of the rotary electric machine, that is supplied from the shaft, and is formed of a plurality of magnetic plates stacked together in the axial direction of the rotary electric machine; and a coolant impermeable nonmagnetic member that is provided in the rotor core near an inner circumferential surface on a radially outer side in a radial direction of the rotor core, of the inner circumferential surface of the coolant flow path.

The disclosure of Japanese Patent Application No. 2012-043934 filed on Feb. 29, 2012 including the specification, drawings and abstract is incorporated herein by reference in its entirety.

### BACKGROUND OF THE INVENTION

1. Field of the Invention

The invention relates to cooling structure of a rotor for a rotary electric machine, and a rotary electric machine provided with this cooling structure. More particularly, the invention relates to a cooling structure of a rotor for a rotary electric machine, which cools a rotor core with coolant supplied from a shaft.

2. Description of Related Art

Conventionally, a rotor of a motor formed by magnetic steel sheets that are stacked together is cooled with cooling oil. For example, Japanese Patent Application Publication No. 2009-71923 (JP 2009-71923 A) describes a cooling structure of an electric motor that aims to make a pump that is provided outside the electric motor compact so that it can be provided inside the electric motor.

This cooling structure of an electric motor has a plurality of cooling oil passages that pass near a plurality of permanent magnets arranged inside a rotor core and that run vertically through the rotor core. An annular groove that communicates with these cooling oil passages is formed in a lower surface portion of a lower plate. The annular groove communicates with a discharge port of a pump that tightly contacts the lower plate. The pump is configured with a rotor shaft as a drive shaft, and is able to deliver oil that is inside an oil reservoir formed in a bottom portion of a motor housing into the cooling oil passages. Accordingly, oil squirted out from the cooling oil passages is able to cool a stator coil and an upper coil end of the stator coil.

With the cooling structure of an electric motor described in JP 2009-71923 A, cooling oil passages are formed extending in an axial direction inside a rotor core formed by multiple magnetic steel sheets that are stacked together. Therefore, cooling oil enters the spaces between the magnetic steel sheets from the cooling oil passages, flows radially outward, and then flows out to a gap portion between the rotor and stator of the rotor due to centrifugal force when the rotor rotates. When this occurs, the rotor is driven with cooling oil interposed in the gap portion, which causes rotational resistance of the rotor, resulting in output loss (hereinafter also referred to as “drag loss”) of the motor.

### SUMMARY OF THE INVENTION

The invention provides a cooling structure of a rotor for a rotary electric machine, with which it is possible to reduce drag loss by inhibiting coolant from entering between magnetic steel sheets from a coolant flow path inside a rotor core, and a rotary electric machine including a rotor for the rotary electric machine that has the cooling structure.

A cooling structure of a rotor for a rotary electric machine according to a first aspect of the invention includes: a rotatable shaft that is configured to supply coolant that flows inside the shaft to outside the shaft; a rotor core that is fitted onto the shaft and fixed thereto, and has a coolant flow path for flowing the coolant, in an axial direction of the rotary electric machine, that is supplied from the shaft, and is formed of a plurality of magnetic plates stacked together in the axial direction of the rotary electric machine; and a coolant impermeable nonmagnetic member that is provided in the rotor core on or near an inner circumferential surface on a radially outer side in a radial direction of the rotor core, of the inner circumferential surface of the coolant flow path.

A cooling structure of a rotor for a rotary electric machine according to a second aspect of the invention includes: a rotatable shaft that is configured to supply coolant that flows inside the shaft to outside the shaft; a rotor core that is fitted onto the shaft and fixed thereto, and has a coolant flow path for flowing the coolant, in an axial direction of the rotary electric machine, that is supplied from the shaft, and is formed of a plurality of magnetic plates stacked together in the axial direction of the rotary electric machine; and a coolant stopping member that is provided in the rotor core on or near an inner circumferential surface on a radially outer side in a radial direction of the rotor core, of the inner circumferential surface of the coolant flow path, and that inhibits the coolant from entering between the magnetic plates.

A rotary electric machine according to a third aspect of the invention includes a stator that generates a rotating magnetic field; and a rotor that is arranged opposing the stator across an air gap, and has the cooling structure according to any one of the structures described above.

In the cooling structure of a rotor for a rotary electric machine according to the invention, the nonmagnetic member or the coolant stopping member is provided on or near the inner circumferential surface on the radially outer side of the coolant flow path, so that coolant is inhibited from entering between the magnetic plates that form the rotor core, flowing radially outward, and then flowing out to the outer circumferential surface of the rotor due to the action of centrifugal force when the rotor rotates. Therefore, it is possible to inhibit coolant from being interposed in the gap portion between the rotor and the stator when the rotor is rotated. As a result, output of the rotary electric machine is improved due to the resultant reduction in drag loss.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a rotary electric machine taken along a plane perpendicular to an axial direction of the rotary electric machine according to one example embodiment of the invention;

FIG. 2 is a partial sectional view of a rotor taken along line II-II in FIG. 1;

FIG. 3 is a partially enlarged view of a portion 13 in FIG. 1;

FIG. 4 is a diagram corresponding to FIG. 2, showing another embodiment of a cooling oil stopping member; and

FIG. 5 is a diagram corresponding to FIG. 2, showing yet another embodiment of a cooling oil stopping member.

### DETAILED DESCRIPTION OF EMBODIMENTS

Hereinafter, example embodiments of the invention will be described in detail with reference to the accompanying drawings. In the description, the specific shapes, materials, numeric values, and directions and the like are merely examples to facilitate understanding of the invention, and may be changed as appropriate according to the use, objective, and specifications and the like. When a plurality of example embodiments or modified examples or the like are included in the description below, appropriate combined usage of the characteristic portions of these is initially assumed.

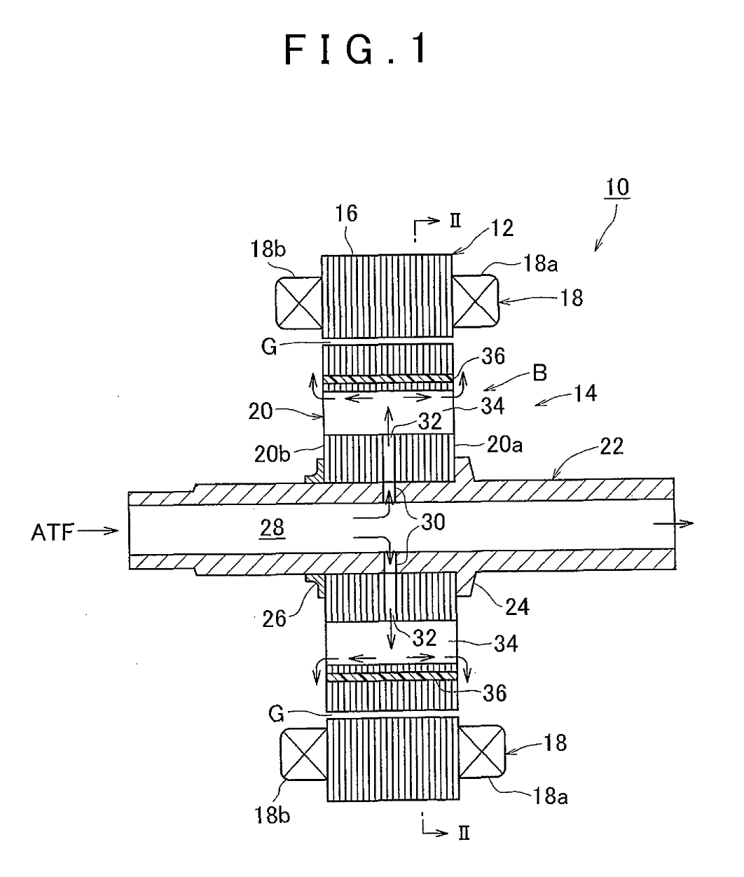

FIG. 1 is a sectional view along an axial direction of a rotary electric machine 10 that includes a rotor cooling structure according to one example embodiment of the invention. As shown in FIG. 1, the rotary electric machine 10 includes a stator 12 and a rotor 14. A radial gap portion G is provided between the stator 12 and the rotor 14. Note that the term indicating the radial direction, such as “radially”, means the radial direction of the rotor, or rotor core, in the specification and claims.

The stator 12 is formed of a cylindrical stator core 16 made of magnetic material, and a stator coil 18 that is wound around a plurality of teeth portions that protrude on an inner circumferential portion of the stator core 16 and are arranged at equally-spaced intervals in a circumferential direction. The stator core 16 is formed by, for example, stacking multiple magnetic steel sheets that have been made by stamping in generally annular shapes, together in the axial direction and then integrally joining them together by at least one of crimping, welding, and adhering or the like.

The stator coil 18 includes intra-slot portions, not shown, that are inserted and arranged between the teeth portions, and coil end portions 18a and 18b that protrude outward from axial end surfaces of the stator core 16. The coil end portions 18a and 18b are each formed in a general annular shape when viewed from the axial direction.

The stator 12 formed of the stator core 16 and the stator coil 18 is housed in a cylindrical case, not shown. At least two bearing members for rotatably supporting a shaft that will be described later are provided, at least one on each side of the case in the axial direction.

The rotor 14 that is arranged on the radially inner side of the stator core 16 includes a cylindrical rotor core 20, and a shaft 22 that passes through the center of the rotor core 20 and extends in the axial direction. The rotor core 20 is fitted onto the shaft 22 and fixed thereto.

The rotor core 20 is formed by stacking multiple magnetic steel sheets (magnetic plates) that have been made by stamping in generally disk-like shapes, together in the axial direction and then integrally joining them together by at least one of crimping, welding, and adhering or the like. The rotor core 20 has generally the same length in the axial direction as that of the stator core 16, and the axial end surfaces are arranged substantially flush with each other.

The shaft 22 is rotatably supported on both end sides by bearing members that are attached to a case within which the rotary electric machine 10 is housed.

The shaft 22 has a flange portion 24 that protrudes radially outward from the outer circumferential surface of the shaft 22. The flange portion 24 abuts against one end surface of the rotor core 20 in the axial direction, and serves to determine the axial position of the rotor core 20 on the shaft 22. A fixing member 26 is fixed on the shaft 22 in a state abutted against the other axial end surface of the rotor core 20. The fixing member 26 is an annular metallic member that is fixed onto the shaft 22 by crimping or the like. The fixing member 26 restricts the rotor core 20 from moving in the axial direction on the shaft 22.

It is possible to fix the circumferential position of the rotor core 20 with respect to the shaft 22 by forming a protruding key on an edge portion of a shaft hole formed in the center of the rotor core 20, and engaging this protruding key with a key groove formed extending in the axial direction in the outer circumferential surface of the shaft 22.

The rotor core 20 may also be fitted onto the shaft 22 for fixation by shrink-fitting or press-fitting or the like, for example. In this case, the fixing member 26 and the key may be omitted.

A coolant flow path 28 for flowing coolant is formed through the shaft 22 in the axial direction. Cooling oil, for example, may be suitably used as the coolant. In FIG. 1, the cooling oil is indicated as ATF (Automatic Transmission Fluid), and the flow of the cooling oil is indicated by the arrows. Hereinafter, the coolant will be described as cooling oil, but it is not limited to this. That is, other coolant may also be used as long as it is able to exhibit good cooling performance with respect to the rotor core 20 that includes permanent magnets.

The coolant flow path 28 in the shaft 22 opens on one end side of the shaft 22, and cooling oil is circulated and supplied from this open portion via an oil pump, an oil cooler, and so on, not shown. As long as the object of the coolant flow path 28 in the shaft 22 is only to supply cooling oil to the rotor core 20, the coolant flow path 28 does not have to pass through to the other end side of the shaft 22, i.e., it may end near a position in the middle of the rotor core 20 in the axial direction.

A plurality of coolant supply passages 30 that communicate with the coolant flow path 28 inside the shaft 22 and open to an outer circumferential surface of the shaft 22 are formed in the shaft 22. The coolant supply passages 30 are passages for supplying the cooling oil that flows through the shaft 22 to the rotor core 20 by centrifugal force that acts on the cooling oil when the rotor 14 rotates. These coolant supply passages 30 are formed in the radial direction at intervals in the circumferential direction of the shaft 22.

Rotor-side coolant supply passages 32 are formed in the rotor core 20 at a center position in the axial direction of the rotor core 20. Radially inner end portions of the coolant supply passages 32 communicate with the coolant supply passages 30 of the shaft 22. The coolant supply passages 30 are formed by forming cutout portions that extend in the radial direction, in magnetic steel sheets corresponding to the center position, from among the multiple magnetic steel sheets that form the rotor core 20.

A radially outer end portion of each of the coolant supply passages 32 of the rotor core 20 communicates with a coolant flow path 34 formed in the rotor core 20.

The coolant flow paths 34 of the rotor core 20 are formed through the rotor core 20 in the axial direction. That is, the coolant flow paths 34 of the rotor core 20 are open at the axial end surfaces 20a and 20b of the rotor core 20.

Moreover, cooling oil stopping members (coolant stopping members) 36 are provided in the rotor core 20. These cooling oil stopping members 36 serve to block cooling oil that flows in the axial direction through the coolant flow paths 34 of the rotor core 20, from entering or seeping into spaces between the magnetic steel sheets, flowing radially outward, and then flowing out to the gap portion G between the outer circumferential surface of the rotor core 20 and the inner circumferential surface of the stator core 16 (i.e., the radially inner side end surface of the teeth portion).

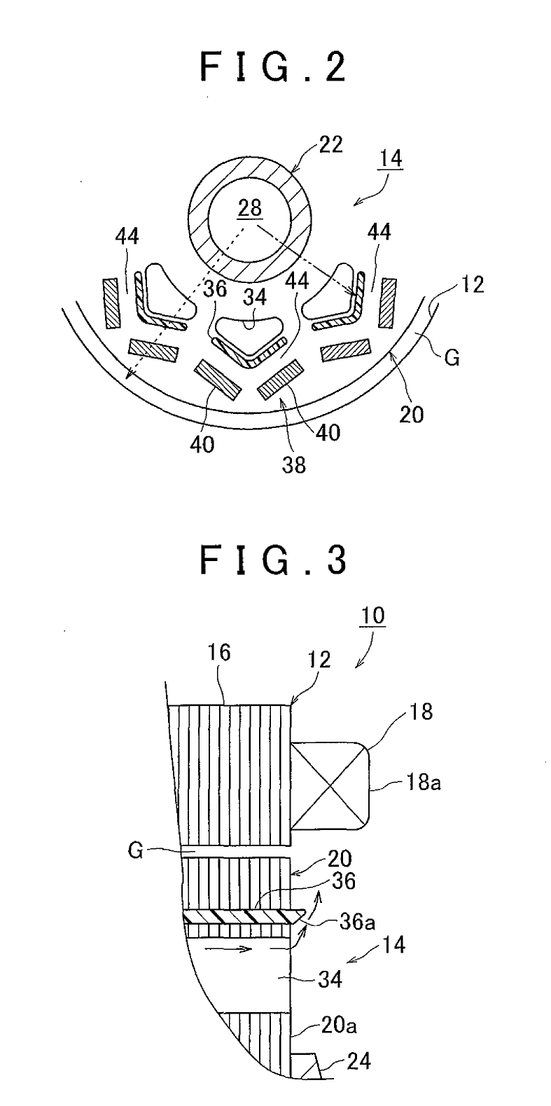

Subsequently, the cooling oil stopping members 36 will be described in detail with reference to FIGS. 2 and 3. FIG. 2 is a partial sectional view of a rotor taken along line II-II in FIG. 1, and FIG. 3 is a partially enlarged view of portion B in FIG. 1.

The rotor 14 of the rotary electric machine 10 of this example embodiment is an interior permanent magnet (IPM) type rotor with permanent magnets 40 embedded in the rotor 14, as shown in FIG. 2. More specifically, in the rotor 14 of this example embodiment, eight magnetic poles 38 are arranged at equally-spaced intervals in the circumferential direction on the outer circumferential portion of the rotor core 20. Two circumferentially-adjacent magnetic poles 38 form four pairs of magnetic poles including N poles and S poles. However, the number of magnetic poles 38 and the number of magnetic pole pairs are not limited to these.

Two permanent magnets 40 are embedded in each magnetic pole 38. Each of the permanent magnets 40 is plate-shaped and has a flat rectangular cross section, and is inserted into a magnet insertion hole and fixed therein, the magnetic insertion hole extending in the axial direction in the rotor core 20. The two of the permanent magnets 40 included in one magnetic pole 38 are arranged in a posture spreading out in a V-shape toward the radial inside of the rotor core 20. The permanent magnets 40 are inserted into the magnet insertion holes that have generally rectangular open portions, and are fixed to the rotor core 20 by adhesion or the like. Therefore, the permanent magnets 40 are prevented from falling out of the rotor core 20 even if the open portions of the magnet insertion holes are not covered by providing an endplate on each end of the rotor core 20 in the axial direction.

The coolant flow path 34 that is formed as a hole that passes through the rotor core 20 in the axial direction in a radially inner area of the rotor core 20 is formed at each of the magnetic poles 38 of the rotor 14. Each of the coolant flow paths 34 has a generally triangular cross section and an open portion, and is formed with the vertex angle portion thereof pointing toward the radially outer side of the center of the magnetic pole. Each coolant flow path 34 includes a cavity that has lower magnetic permeability than the rotor core 20, so that the coolant flow paths 34 also serve as flux barriers in the magnetic poles 38. Therefore, magnetic flux passages 44 each formed by a generally V-shaped magnetic body portion are formed between the permanent magnets 40 and the coolant flow paths 34 in the magnetic poles 38.

By having the coolant flow paths 34 of the magnetic poles 38 form flux barriers in this way, processing of the magnetic steel sheets that form the rotor core 20 is simplified and decrease in the strength of the rotor core 20 to withstand the centrifugal force and the like is reduced, compared with the case where the coolant flow paths 34 and the flux barriers are formed as separate through-holes.

The shape of the coolant flow paths 34 is not limited to a generally triangular shape. That is, the shape of the coolant flow paths 34 may be set appropriately according to the arrangement of the permanent magnets 40, taking into account the fact that the coolant flow paths 34 also serve as flux barriers. For example, the coolant flow paths 34 may also be formed in a rectangular shape.

The cooling oil stopping members (i.e., the coolant stopping members) 36 are embedded in the magnetic flux passages 44 between the permanent magnets 40 and the coolant flow paths 34 in the magnetic poles of the rotor 14. Each cooling oil stopping member 36 is formed inside the rotor core 20 near the inner circumferential surface of the coolant flow path 34 that is on the outer side in the radial direction of the rotor core 20. More specifically, each of the cooling oil stopping members 36 is formed in a substantially V-shape leaving a narrow bridge portion between the cooling oil stopping member 36 and the inner circumferential surface, on the radially outer side, of the corresponding coolant flow path 34. Here, the bridge portions between the coolant flow paths 34 and the cooling oil stopping members 36 are preferably formed narrow so that a flow of magnetic flux that would affect the magnetic characteristics of the magnetic poles 38 of the rotor 14 will not occur.

The cooling oil stopping members 36 serve to inhibit coolant from entering between the magnetic steel sheets that form the rotor core 20. In order to carry out this function, the cooling oil stopping members 36 are preferably made of cooling oil impermeable material, and preferably made of nonmagnetic material so as not to affect the magnetic characteristics of the rotor 14. Therefore, resin is preferably used as the material of the cooling oil stopping members 36. However, the cooling oil stopping members 36 may also be made of material other than resin as long as the material is both cooling oil impermeable and nonmagnetic.

The cooling oil stopping members 36 embedded in the rotor core 20 may be formed by injecting and filling molten resin into V-shaped through-holes formed through the rotor core 20 in the axial direction. The manufacturing process can be simplified if this filling process is performed simultaneously with the filling of resin into the magnet insertion holes. Alternatively, the cooling oil stopping members 36 may be formed by resin molded articles that have been molded in advance, and then inserted from the axial direction into V-shaped through-holes formed in the rotor core 20 and fixed by adhesion or the like.

FIG. 3, is a partially enlarged view of portion B in FIG. 1. As shown in FIG. 3, the cooling oil stopping member 36 may extend through in the axial direction in the rotor core 20, and the axial end portion (only one end portion is shown here) of the cooling oil stopping member 36 may form a protruding portion 36a that protrudes from an axial end surface 20a of the rotor core 20. The protruding portion 36a may have a generally triangular shape as shown in FIG. 3, or it may have another shape. By having the end portion of the cooling oil stopping member 36 be the protruding portion 36a in this way, the cooling oil that has flowed out from the coolant flow path 34 to the axial end surface 20a of the rotor core 20 is deflected away from the axial end surface 20a of the rotor core 20 by the protruding portion 36a when the cooling oil is sprayed radially outward by centrifugal force. As a result, the cooling oil will not easily enter the gap portion G between the rotor 14 and the stator 12, which in turn contributes to a reduction in drag loss of the rotary electric machine 10.

Next, the cooling operation in the rotary electric machine 10 having the foregoing structure will be described.

Cooling oil delivered by the oil pump is supplied to the coolant flow path 28 from one end portion of the shaft 22. The cooling oil supplied to the coolant flow path 28 flows in the axial direction and is supplied to the coolant flow paths 34 of the rotor core 20 via the coolant supply passages 30 of the shaft 22 and the coolant supply passages 32 in the rotor core 20.

The cooling oil that has flowed into the coolant flow paths 34 at a central position of the rotor core 20 in the axial direction is divided into two flows, one to each side in the axial direction. Then the cooling oil that has flowed to the axial end surfaces 20a and 20b of the rotor core 20 flows out from the open portions that are the end portions of the coolant flow paths 34, and is sprayed radially outward by the action of centrifugal force. Then, the cooling oil splashes on the coil end portions 18a and 18b of the stator coil 18 that is wound around the stator 12, and is able to cool the stator coil 18 and thus the stator 12.

By having the cooling oil supplied from the shaft 22 flow through the rotor core 20 in this way, the rotor core 20 that has increased in temperature due to the effect of an eddy current or the like from magnetic flux variation when the rotary electric machine 10 is rotated, as well as the permanent magnets 40 that are embedded in the rotor core 20, are effectively cooled, so that demagnetization of the permanent magnets 40 is reduced.

When cooling oil flows in the axial direction through the coolant flow paths 34 in the rotor core 20, force that pushes radially outward acts on the cooling oil by the action of centrifugal force. Therefore, cooling oil may enter the spaces between the magnetic steel sheets that form the inner wall surface positioned on the radially outer side of the coolant flow paths 34. If this happens and the cooling oil stopping members 36 are not provided, then when the cooling oil flows out to the outer circumferential surface of the rotor core 20 via a bridge portion between the two magnet insertion holes of each magnetic pole 38, drag loss would occur due to cooling oil being interposed in the gap portion G between the rotor 14 and the stator 12. The general flow of the cooling oil at this time is indicated by the broken arrow in FIG. 2.

In contrast, in the rotor 14 of this example embodiment, the cooling oil stopping members 36 are provided near the radially outer side of the coolant flow paths 34, so that cooling oil that has entered between the magnetic steel sheets is blocked by the cooling oil stopping members 36. The manner in which the flow of cooling oil is blocked at this time is indicated by the chain double-dashed arrow in FIG. 2. Accordingly, the cooling oil is inhibited from flowing out to the outer circumferential surface of the rotor core 20. Therefore, drag loss of the rotary electric machine 10 that occurs due to cooling oil being interposed in the gap portion G between the rotor 14 and the stator 12 is reduced.

In this example embodiment, the cooling oil stopping members 36 are shaped in a generally V-shape, and are recessed pans that receive cooling oil that has seeped in between the magnetic steel sheets, so that cooling oil that has entered from the coolant flow paths 34 is reliably blocked.

Furthermore, in this example embodiment, the axial end portions of the cooling oil stopping members 36 are the protruding portions 36a that protrude from the axial end surfaces 20a and 20b of the rotor core 20, so that cooling oil that has flowed out from the coolant flow paths 34 to the axial end surface 20a of the rotor core 20 is deflected away from the axial end surface 20a of the rotor core 20 by the protruding portions 36a when the cooling oil is sprayed radially outward by centrifugal force, as described above. As a result, cooling oil will not easily enter the gap portion G between the rotor 14 and the stator 12, which contributes to a reduction in drag loss of the rotary electric machine 10.

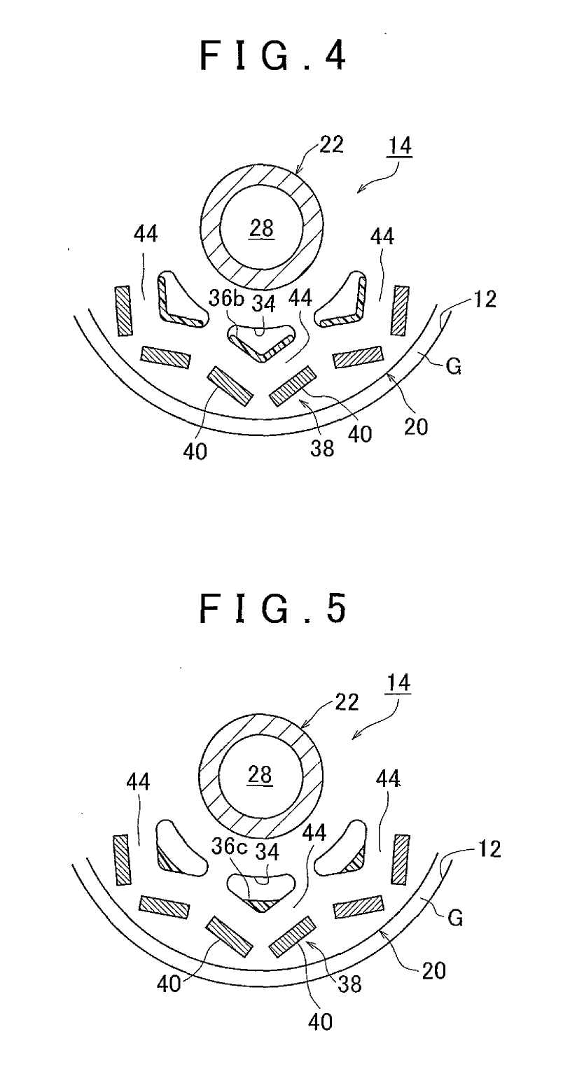

Next, cooling oil stopping members 36b according to another embodiment will be described with reference to FIG. 4. The cooling oil stopping members 36b differ from the cooling oil stopping members 36 according to the example embodiment described above in that they are provided on the inner circumferential surface on the outer radial side, of the inner circumferential surface of the coolant flow paths 34 of the rotor core 20. More specifically, each of the cooling oil stopping members 36b is provided in a generally V-shape covering all, or substantially all of the inner circumferential surface on the radially outer side that corresponds to two side portions that form the vertex angle portion of the coolant flow path 34 that has a generally triangular shape. The cooling oil stopping members 36b may be formed by resin injection molding, or resin molded articles that have been molded in advance may be inserted into the coolant flow paths 34 from the axial direction and fixed by adhesion or the like. The structure other than this is similar to that in the example embodiment described above, so redundant descriptions will be omitted here.

In this way, drag loss may be reduced by inhibiting cooling oil from entering the spaces between the magnetic steel sheets, by providing the cooling oil stopping members 36b on the inner circumferential surface on the radially outer side of the rotor core 20. Also, in this case, there is also the advantage that the magnetic flux passages 44 between the permanent magnets 40 and the coolant flow paths 34 that serve as flux barriers can be ensured to be comparatively wide.

Next, cooling oil stopping members 36c according to yet another embodiment will be described with reference to FIG. 5. The cooling oil stopping members 36c in this example are provided on the inner circumferential surface on the radially outer side, of the inner circumferential surface of the coolant flow paths 34 of the rotor core 20, similar to the cooling oil stopping members 36b described with reference to FIG. 4 above. However, each of the cooling oil stopping members 36c is provided covering the inner circumferential surface near the vertex angle portion of the coolant flow path 34 that has a generally triangular shape. The structure other than this is similar to that in the example embodiment described above, so redundant descriptions will be omitted here.

Even if the cooling oil stopping members 36c are provided covering only a portion near the vertex angle portion of the inner circumferential surface on the radially outer side of the coolant flow paths 34 in this way, when the amount of cooling oil that is supplied and flows to the coolant flow paths 34 is small, this cooling oil will flow mainly near the vertex angle portion in the coolant flow paths 34 due to the action of centrifugal force, so there is an effect of inhibiting the cooling oil from entering between the magnetic steel sheets. The cooling oil stopping members 36c in this case may also be formed by resin injection molding, or resin molded articles that have been molded in advance may be inserted into the coolant flow paths 34 from the axial direction and fixed by adhesion or the like.

The cooling structure of a rotary electric machine according to the invention is not limited to the structures described above. That is, various modifications and improvements without departing from the scope of the invention are also possible.

For example, in the description above, the rotor 14 of the rotary electric machine 10 is an IPM type rotor with permanent magnets 40 embedded therein, but the invention is not limited to this. The cooling oil stopping members may also be used in a case in which a rotor that does not include permanent magnets is cooled by cooling oil supplied from a shaft.

Also, in the description above, the coolant flow paths 34 form flux barriers, but the invention is not limited to this. Cooling oil stopping members may also be used in cooling flow paths that are paths formed separately from flux barriers.

Furthermore, in the description above, the rotor does not have an end plate, but an end plate may also be provided on one end or each end of the rotor core in the axial direction. In this case, cooling oil outlets that communicate with the coolant flow paths of the rotor core are formed in the end plate(s). In addition, in this case, it is not necessary to provide protruding portions on the end portions of the cooling oil stopping members as described above.

An axial end portion of the nonmagnetic member or the cooling oil stopping member may form a protruding portion that protrudes from an axial end surface of the rotor core.

The rotor core may include a magnetic pole in which a permanent magnet is embedded, and the coolant flow path of the rotor core may form a flux barrier that opposes the permanent magnet of the magnetic pole across a magnetic flux passage.

What is claimed is:

1. A cooling structure of a rotor for a rotary electric machine, comprising:
a rotatable shaft that is configured to supply coolant that flows inside the shaft to outside the shaft;
a rotor core that is fitted onto the shaft and fixed thereto, and has a coolant flow path for flowing the coolant, in an axial direction of the rotary electric machine, that is supplied from the shaft, and is formed of a plurality of magnetic plates stacked together in the axial direction of the rotary electric machine; and
a coolant impermeable nonmagnetic member that is provided in the rotor core on or near an inner circumferential surface on a radially outer side in a radial direction of the rotor core, of the inner circumferential surface of the coolant flow path.

2. The cooling structure according to claim 1, wherein
an axial end portion of the nonmagnetic member forms a protruding portion that protrudes from an axial end surface of the rotor core.

3. The cooling structure according to claim 1, wherein
the rotor core includes a magnetic pole in which a permanent magnet is embedded, and
the coolant flow path of the rotor core forms a flux barrier that opposes the permanent magnet of the magnetic pole across a magnetic flux passage.

4. The cooling structure according to claim 1, wherein
the shaft has a hollow structure having a coolant flow path therein for flowing the coolant in the axial direction and has a coolant supply passage that communicates with the coolant flow path of the shaft and that is open to an outer circumferential surface of the shaft.

5. The cooling structure according to claim 4, wherein
the rotor core has a coolant supply passage, a radially inner end portion of which communicates with the coolant supply passage of the shaft, a radially outer end portion of which communicates with the coolant flow path of the rotor core.

6. The cooling structure according to claim 1, wherein
a cross section of the coolant flow path of the rotor core that is taken along a plane perpendicular to the axial direction has a shape convex outwardly in the radial direction, and
at least an outermost portion, in the radial direction, of the coolant flow path of the rotor core is covered by the nonmagnetic member.

7. A cooling structure of a rotor for a rotary electric machine, comprising:
a rotatable shaft that is configured to supply coolant that flows inside the shaft to outside the shaft;
a rotor core that is fitted onto the shaft and fixed thereto, and has a coolant flow path for flowing the coolant, in an axial direction of the rotary electric machine, that is supplied from the shaft, and is formed of a plurality of magnetic plates stacked together in the axial direction of the rotary electric machine; and
a coolant stopping member that is provided in the rotor core on or near an inner circumferential surface on a radially outer side in a radial direction of the rotor core, of the inner circumferential surface of the coolant flow path, and that inhibits the coolant from entering between the magnetic plates.

8. The cooling structure according to claim 7, wherein
an axial end portion of the coolant stopping member forms a protruding portion that protrudes from an axial end surface of the rotor core.

9. The cooling structure according to claim 7, wherein
the rotor core includes a magnetic pole in which a permanent magnet is embedded, and
the coolant flow path of the rotor core forms a flux barrier that opposes the permanent magnet of the magnetic pole across a magnetic flux passage.

10. The cooling structure according to claim 7, wherein
the shaft has a hollow structure having a coolant flow path therein for flowing the coolant in the axial direction and has a coolant supply passage that communicates with the coolant flow path of the shaft and that is open to an outer circumferential surface of the shaft.

11. The cooling structure according to claim 10, wherein
the rotor core has a coolant supply passage, a radially inner end portion of which communicates with the coolant supply passage of the shaft, a radially outer end portion of which communicates with the coolant flow path of the rotor core.

12. The cooling structure according to claim 7, wherein
a cross section of the coolant flow path of the rotor core that is taken along a plane perpendicular to the axial direction has a shape convex outwardly in the radial direction, and
at least an outermost portion, in the radial direction, of the coolant flow path of the rotor core is covered by the coolant stopping member.

13. A rotary electric machine comprising:
a stator that generates a rotating magnetic field; and
a rotor that is arranged opposing the stator across an air gap, and has the cooling structure according to claim 1.

14. A rotary electric machine comprising:
a stator that generates a rotating magnetic field; and
a rotor that is arranged opposing the stator across an air gap, and has the cooling structure according to claim 7.
